(19) United States
(12) Patent Application Publication
(10) Pub. No.: US 2008/0113876 A1
(43) Pub. Date: May 15, 2008

(54) Probe array and associated methods

(76) Inventors: Won-sun Kim, Suwon-si (KR); Sung-min Chi, Hwaseong-si (KR); Jung-hwan Hah, Hwaseong-si (KR); Kyoung-seon Kim, Suwon-si (KR); Sang-jun Choi, Seoul (KR); Man-hyoung Ryoo, Hwaseong-si (KR)

Correspondence Address: LEE & MORSE, P.C., 3141 FAIRVIEW PARK DRIVE, SUITE 500, FALLS CHURCH, VA, 22042, US

(21) Appl. No.: 11/889,455

(22) Filed: Aug. 13, 2007

(30) Foreign Application Priority Data
Aug. 14, 2006 (KR) 10-2006-0076900

(51) Int. Cl. C40B 30/04; C40B 40/00; C40B 50/18

(52) U.S. Cl. 506/9; 506/13; 506/32

(57) ABSTRACT

A probe array includes a substrate having at least two projecting features adjacent to one another, each feature including a top surface and a side surface, an isolation region separating the at least two features, at least two active regions, the at least two active regions including the top surfaces of the at least two features, and an inactive region separating the at least two active regions, the inactive region including the isolation region.

### BACKGROUND OF THE INVENTION

1. Field of the Invention

Embodiments relate to a probe array and, more particularly, to a probe array that may be implemented as an oligomer probe array exhibiting an increased signal-to-noise ratio (SNR), a method of fabricating the same, and a method of analyzing a sample using the same.

2. Description of the Related Art

Oligomer probe arrays are tools that are widely used for gene expression profiling, genotyping, detection of mutations such as single nucleotide polymorphisms (SNPs) and polymorphisms, analysis of proteins and peptides, screening of potential medicine, development and production of new medicine, or the like.

A conventional oligomer probe array is formed by irradiating light, e.g., ultraviolet (UV) light, onto a specific region on a substrate, thus optically activating the region, and in situ synthesizing oligomer probes onto the region. However, when a photolithography process for the in situ synthesis is repeated several times, a mask may be misaligned. As a result, a part of a region that should not be activated may be inadvertently activated, and oligomer byproducts may also be formed in this region, which may lower the SNR of the oligomer probe array. The low SNR may hinder accurate analysis of hybridization data with a target sample.

Furthermore, the form of genetic information, which may be analyzed using an oligomer probe array, has diversified from genes to nucleotides, the smallest units of DNA. Accordingly, a design rule of a probe cell may be reduced from tens of μm to less than several μm, which may adversely affect the SNR and the accuracy of the data analysis.

### SUMMARY OF THE INVENTION

Embodiments are therefore directed to a probe array and associated methods, which substantially overcome one or more of the problems due to the limitations and disadvantages of the related art.

It is therefore a feature of an embodiment of the present invention to provide a probe array including active regions and inactive regions separating adjacent active regions.

It is therefore another feature of an embodiment of the present invention to provide a method of fabricating a probe array including active regions and inactive regions separating adjacent inactive regions, wherein inactive regions are formed using barrier walls.

It is therefore another feature of an embodiment of the present invention to provide a method of analyzing a sample using a probe array, wherein at least a portion of the sample is bound to active regions that are separated by inactive regions.

At least one of the above and other features and advantages of the present invention may be realized by providing a probe array, including a substrate having at least two projecting features adjacent to one another, each feature including a top surface and a side surface, an isolation region separating the at least two features, at least two active regions, the at least two active regions including the top surfaces of the at least two features, and an inactive region separating the at least two active regions, the inactive region including the isolation region.

The inactive region may include the side surfaces of the features. The active regions may have probes coupled thereto, and the inactive region may have no probes coupled thereto. The probes may be oligomer probes.

The active regions may include a linker, and the inactive region may not include the linker. The top surfaces and the side surfaces all may include a first type of functional group, the linker may be bonded to the functional group on the top surfaces, and the linker may not be bonded to the functional group on the side surfaces. The linker may be a silane-based linker or a siloxane-based linker. The inactive region may include the side surfaces.

The features may be silicon oxide, siloxane, or polymeric. The top surfaces may be convoluted. The substrate may be a silicon substrate or a transparent glass substrate, and the isolation region may be an exposed surface of the substrate.

At least one of the above and other features and advantages of the present invention may be realized by providing a method of fabricating a probe array, the method including forming at least two projecting features adjacent to one another on a substrate, each feature including a top surface and a side surface, and an isolation region separating the at least two features, and forming at least two active regions, the at least two active regions including the top surfaces of the at least two features, and an inactive region separating the at least two active regions, the inactive region including the isolation region.

The inactive region may include the side surfaces of the features. Forming the active regions and the inactive region may include forming barrier walls in the isolation region. The barrier walls may extend above the top surfaces of the features. The barrier walls may include one or more of a photoresist or a photoreactive polymer.

The method may further include binding probes to the active regions. The inactive region may include the side surfaces. The probes may be oligomer probes. Binding the probes to the active regions may include binding a linker to the active regions while the barrier walls are in the isolation region, and then removing the barrier walls. Binding the probes to the active regions may include binding the probes to the active regions while the barrier walls are in the isolation region, and then removing the barrier walls. The top surfaces may be convoluted.

At least one of the above and other features and advantages of the present invention may be realized by providing a method of analyzing a sample using a probe array, the method including applying a sample to the probe array, binding at least a portion of the applied sample to one or more active regions of the probe array, and detecting bound portions of the sample. The probe array may include a substrate having at least two projecting features adjacent to one another, each feature including a top surface and a side surface, an isolation region separating the at least two features, at least two active regions, the at least two active regions including the top surfaces of the at least two features, and an inactive region separating the at least two active regions, the inactive region including the isolation region.

### BRIEF DESCRIPTION OF THE DRAWINGS

The above and other features and advantages will become more apparent to those of ordinary skill in the art by describing in detail example embodiments with reference to the attached drawings, in which:

FIGS. 1A and 1B illustrate layouts of a probe array having a plurality of probe cell actives according to an embodiment;

FIG. 2 illustrates a cross-sectional view of a probe array including a plurality of probe cell actives with inactive edge walls according to an embodiment;

FIGS. 3A and 3B illustrate layouts of a probe array having a plurality of probe cell actives according to another embodiment;

FIG. 4 illustrates a cross-sectional view of a probe array including a plurality of probe cell actives with inactive edge walls according to another embodiment;

FIGS. 5A through 5I illustrate cross-sectional views of stages in a method of fabricating the probe array illustrated in FIG. 2 according to an embodiment;

FIG. 6 illustrates a schematic diagram of a mechanism in which the shape of edge walls of a linker varies according to the presence or absence of barrier walls;

FIGS. 7A through 7D illustrate cross-sectional views of stages in a method of fabricating the probe array illustrated in FIG. 4 according to another embodiment;

FIGS. 8A and 8B illustrate cross-sectional views of stages in a method of fabricating the probe array illustrated in FIG. 4 according to another embodiment;

FIGS. 9A through 9C illustrate a contrast measurement, a scanning electron microscope (SEM) cross-sectional view, and a SEM plan view, respectively, of an Example oligomer probe array fabricated in accordance with an embodiment; and

FIGS. 10A through 10C illustrate a contrast measurement, a SEM cross-sectional view, and a SEM plan view, respectively, of a Comparative Example oligomer probe array.

### DETAILED DESCRIPTION OF THE INVENTION

Korean Patent Application No. 10-2006-0076900, filed on Aug. 14, 2006, in the Korean Intellectual Property Office, and entitled: “Oligomer Probe Array Having Probe Cell Actives with Inactivated Edge Walls and Method of Fabricating the Same,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

As used herein, the singular forms are intended to include the plural forms as well, unless the context clearly indicates otherwise. It will be further understood that the terms “includes” and/or “including,” when used in this specification, specify the presence of stated components, steps, operations and/or groups, but do not preclude the presence or addition of one or more other components, steps, operations, and/or groups thereof.

Embodiments are described herein with reference to idealized cross-sectional illustrations and/or schematic illustrations. As such, variations from the shapes of the illustrations, as a result, for example, of manufacturing techniques and/or tolerances, are to be expected. Thus, the described embodiments are not to be construed as limited to the particular shapes of regions illustrated herein, and may include deviations in shapes that result, for example, from manufacturing.

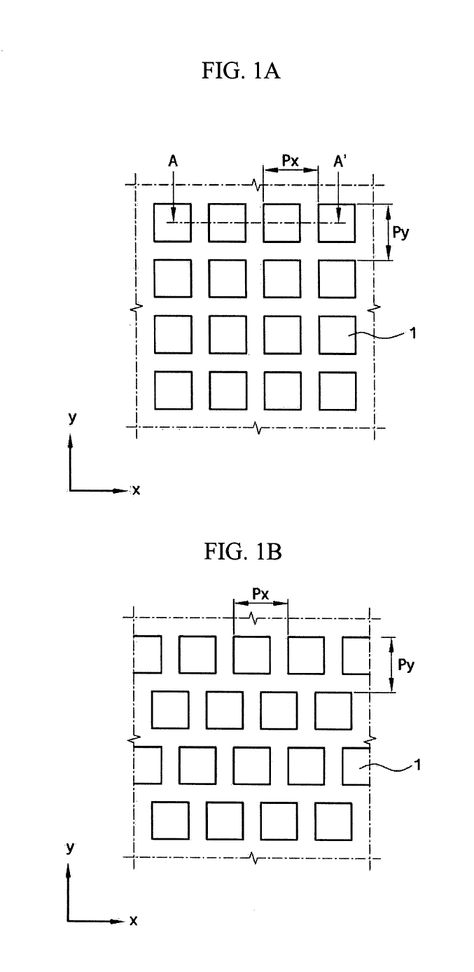

FIGS. 1A and 1B illustrate layouts of a probe array having a plurality of probe cell actives according to an embodiment.

Referring to FIG. 1A, rows and columns of the probe cell active patterns 1 may be arranged in a matrix form. The probe cell active patterns 1 may be arranged along the directions of X- and Y-axes with a first pitch Px and a second pitch Py, respectively. In FIG. 1A, the first pitch Px and the second pitch Py are equal to each other, although they may vary according to layout needs.

Referring to FIG. 1B, odd-numbered rows of probe cell active patterns 1 may be separated from one another by a predetermined pitch Px. In addition, even-numbered rows of probe cell active patterns 1 may be arranged at intervals of the predetermined pitch Px and may be shifted, e.g., in a row direction, to partially overlap the odd-numbered rows of the probe cell active patterns 1. The odd-numbered rows and the even-numbered rows may alternate with each other.

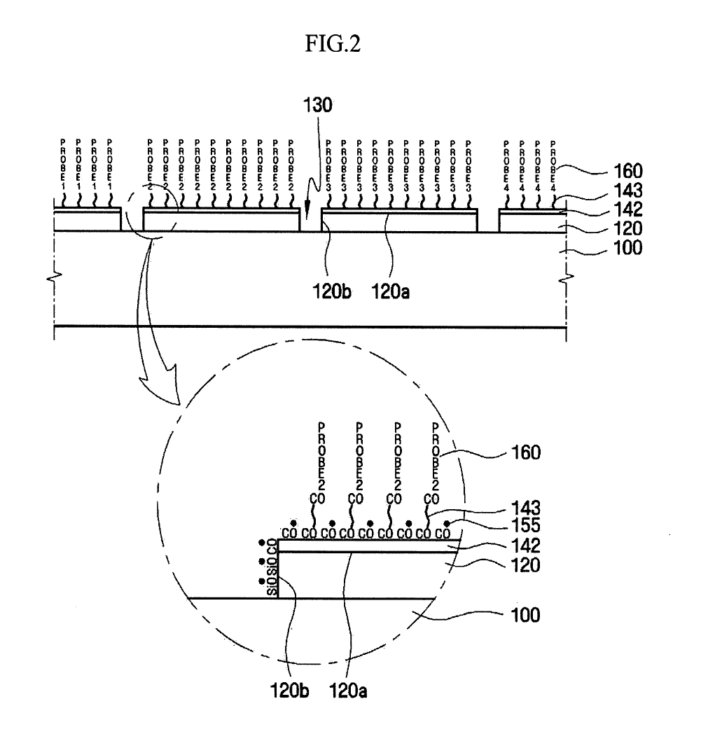

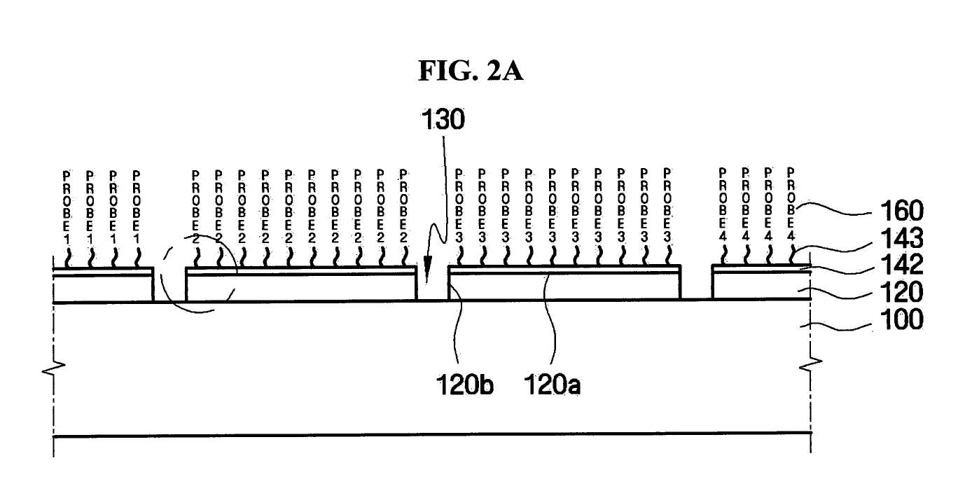

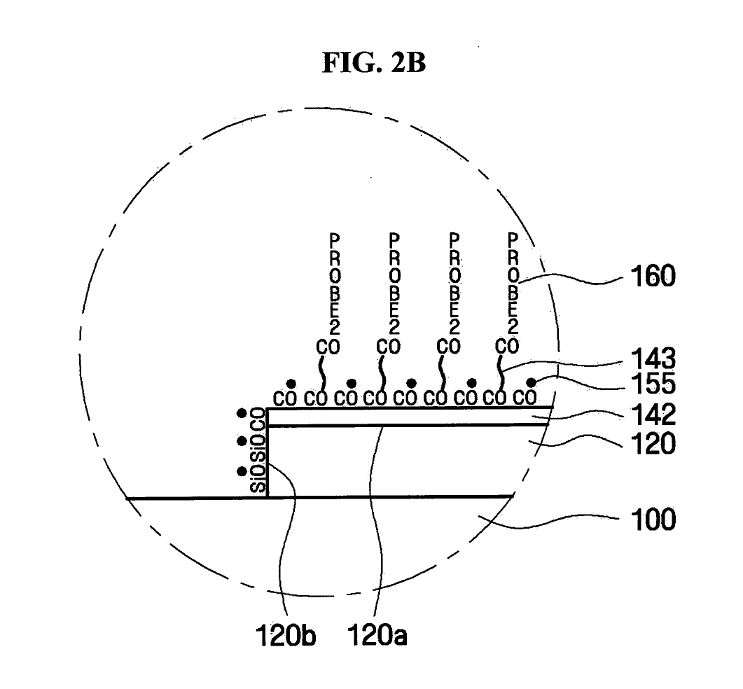

FIG. 2 illustrates a cross-sectional view of a probe array including a plurality of probe cell actives with inactive edge walls according to an embodiment. In FIG. 2, the plurality of probe cell actives 120 may be fabricated using the layouts illustrated in FIGS. 1A and/or 1B.

Referring to FIG. 2, the probe array may include the probe cell actives 120, which may be patterned on a substrate 100. The probe cell actives 120 may have a three-dimensional (3D) structure that projects from the substrate 100, and may be physically separated from one another. A linker 142 may be connected to a top surface 120a of each of the probe cell actives 120. The linker 142 may not be connected to edge walls 120b. Probes 160 may be connected to the linker 142. In an implementation, the probes 160 may be oligomer probes.

A plurality of probe cell isolation regions 130 may physically separate the probe cell actives 120, and may not include functional groups coupled to the linker 142. In addition, the edge walls 120b of the probe cell actives 120 may not be coupled to the probes 160. Capping groups 155 may be coupled to functional groups of the probe cell actives 120 that are not coupled to the linker 142. As a result, the probe cell actives 120 may be physically separated from one another and may also be chemically separated. Consequently, the gap between the probe cell actives 120 may be reduced, and crosstalk between adjacent probe cells may be reduced or prevented.

In an implementation (not shown), capping groups 155 may also be coupled to the edge walls 120b of the probe cell actives 120 in order to inactivate the edge walls 120b, which may prevent the linker 142 and/or probes 160 from coupling to the edge walls 120b.

The substrate 100 may be formed of a material that can reduce or eliminated undesired non-specific binding during hybridization. In addition, the substrate 100 may be formed of a material that is transparent to visible light and/or UV light. The substrate 100 may be a flexible or rigid substrate. Examples of a flexible substrate include a membrane or plastic film such as nylon and nitrocellulose. Examples of a rigid substrate include a silicon substrate, a quartz substrate, a glass substrate such as soda lime glass, and a glass substrate having pores of a predetermined size.

In the case of the silicon substrate, the quartz substrate, or the glass substrate, non-specific binding may not occur or may occur only to a limited extent during hybridization. In addition, since the glass substrate may be transparent to visible light and/or UV light, a fluorescent material may be easily detected during use of the probe array.

When a silicon substrate or a glass substrate is used as the substrate 100, various thin-film fabrication processes and photolithography processes that are well-established for fabricating semiconductor devices and/or liquid crystal display (LCD) panels may be employed to fabricate the probe array. Hence, it may be desirable, from the perspective of fabrication process, that the probe cell isolation regions 130 be exposed surfaces of a silicon substrate or exposed surfaces of a glass substrate.

The probe cell actives 120 may be formed of a material that is substantially stable under a hybridization analysis condition, e.g., a material that is not hydrolyzed when contacting phosphate of pH 6-9 or a TRIS buffer. In addition, the probe cell actives 120 may be formed of a material that may be stably formed as a film and easily patterned on the substrate 100, e.g., using semiconductor and/or LCD fabrication techniques. Also, the probe cell actives 120 may be formed of a material providing functional groups that can be coupled to the linker 142 through various surface treatments such as ozone treatment, acid treatment, base treatment, etc.

A functional group or a coupling group, as used herein, denotes a group that can be used as a starting point of an organic synthesis process. The functional group or the coupling group may be a group that can be covalently or non-covalently bonded. The functional or coupling groups may be suitable for binding with siloxanes or organic compounds.

In an implementation, the probe cell actives 120 may be formed of a silicon oxide film such as a plasma-enhanced tetraethylorthosilicate (PE-TEOS) film, a high density plasma (HDP) oxide film, a P—SiH₄ oxide film, i.e., an oxide film formed by plasma in a SiH₄ gas environment, or a thermal oxide film, a silicate such as a hafnium silicate or a zirconium silicate, a silicon oxy-nitride film, a spin-on siloxane film, a polymer such as polyacrylate, polystyrene, polyvinyl, a copolymer thereof, or a mixture thereof, etc.

The linker 142 may be provided to enable the probes 160 to freely interact, e.g., hybridize, with a target sample and to be coupled to the probe cell actives 120. The length of the linker 142 may be sufficient to enable the probes 160 to freely interact with the target sample. In an implementation, the length of the linker 142 molecules may be about 6 to about 50 atoms. The linker 142 may also be provided to couple the probe cell actives 120 to the probes 160 when the probe cell actives 120 and the probes 160 cannot be directly coupled to each other. The linker 142 may include coupling groups that can be coupled to the probe cell actives 120 and functional groups that can be directly or indirectly coupled to the probes 160.

Indirect coupling may be provided to couple the linker 142 to the probes 160 using another linker 143 interposed therebetween, as illustrated in FIG. 2. When the linker 142 is coupled to the probes 160 by the other linker 143 interposed therebetween, the linker 142 may be formed of a material having coupling groups that can be coupled to the probe cell actives 120 and functional groups that can be coupled to the other linker 143. Although, the linker 142 may be indirectly coupled to the probes 160 by the other linker 143 interposed therebetween, as illustrated in FIG. 2, it will be appreciated that this is merely an example, and the other linker 143 may be omitted such that the linker 142 may be directly coupled to the probes 160. In this case, the linker 142 may include coupling groups that can be coupled to the probe cell actives 120 and functional groups that can be coupled directly to the probes 160.

In addition, protecting groups for storage may be attached to the linker 142. A protecting group denotes a group that blocks a position to which the protecting group is attached from participating in chemical reactions. De-protection denotes detaching the protecting group from the position and thus enabling the position to participate in chemical reactions. For example, acid-labile or photo-labile protecting groups may be attached to the functional groups of the linker 142, and thus may protect the functional groups of the linker 142. Then, the acid-labile or photo-labile protecting groups may be removed, thereby exposing the functional groups of the linker 142, before the coupling of monomers for in situ photolithography synthesis or before the coupling of probes 160 such as synthetic oligomers.

In an implementation, referring to FIG. 2, each of the probe cell actives 120 may be formed of, e.g., a silicon oxide film, a silicate, a silicon oxy-nitride film or a spin-on siloxane film, in which case silanol (SiOH) functional groups, may be exposed on a surface of each of the probe cell actives 120. In this case, a silane-based linker or a siloxane-based linker may be used, which may include coupling groups that can react both with SiOH, to generate a siloxane (Si—O) bond, and functional groups that can be organically coupled to the other linker 143 or the oligomer probes 160. Examples of the coupling groups may include, e.g., —Si(OMe)₃, —SiMe(OMe)₂, —SiMeCl₂, —SiMe(OEt)₂, —SiCl₃, and —Si(OEt)₃ groups. In addition, examples of the functional groups may include, e.g., an organic hydroxy group and an organic amine group. In an implementation, the silane-based linker may be formed of an alkoxy silane-based material having the functional groups, a mixture of activated silane having functional groups and inactivated silane without functional groups, or an alkoxy silane-based material that can be dissolved by light, heat or acid to generate the functional groups. Specific examples of the material of the silane-based linker include N-(3-triethoxysilylpropyl)-4-hydroxybutyramide, N,N-bis(hydroxyethyl)aminopropyltriethoxysilane, acetoxypropyltriethoxysilane, 3-glycidoxypropyltrimethoxysilane, and poly(dimethyl siloxane). Further examples include a silicon compound as disclosed in International Patent Publication No. WO 00/21967, and materials disclosed in U.S. Pat. Nos. 6,989,267 and 6,444,268, the disclosures of these three references being incorporated herein by reference.

If the probe cell actives 120 are formed of polymers, a silane-based or siloxane-based linker 142 that includes acrylic, styryl, or vinyl groups as the coupling groups may be used.

The other linker 143 may be provided to couple the linker 142 to the probes 160. The other linker 143 may be formed of, e.g., a material that can generate coupling groups that can easily react with the organic functional groups of the linker 142, as well as functional groups that can be dissolved by light, heat or acid and thus coupled to the probes 160 or monomers for in situ synthesis. In FIG. 2, organic hydroxy groups are illustrated as the functional groups of the linker 142 and the other linker 143.

FIGS. 3A and 3B illustrate layouts of a probe array having a plurality of probe cell actives according to another embodiment.

The layouts illustrated in FIGS. 3A and 3B may be substantially the same as those illustrated in FIGS. 1A and 1B, having in addition thereto a plurality of groove patterns 2 that may be arranged in each of probe cell active patterns 1 of FIGS. 3A and 3B in order to make a surface of each of the probe cell active patterns 1 convoluted, thereby increasing the surface area of the probe cell active patterns 1.

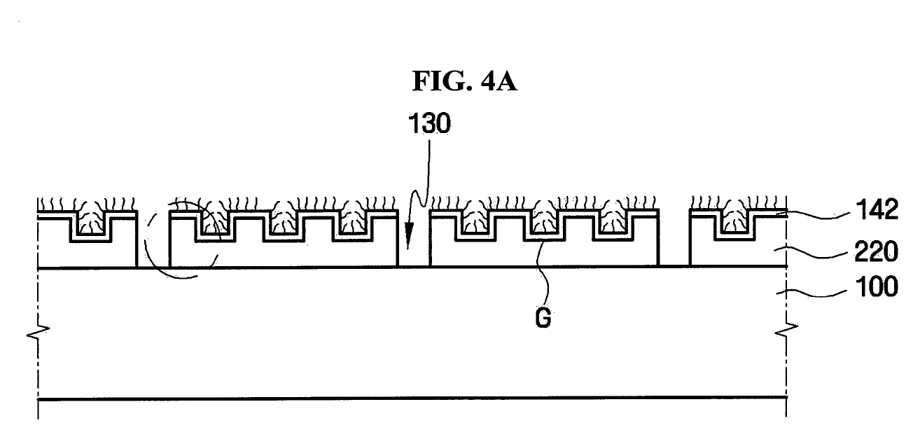

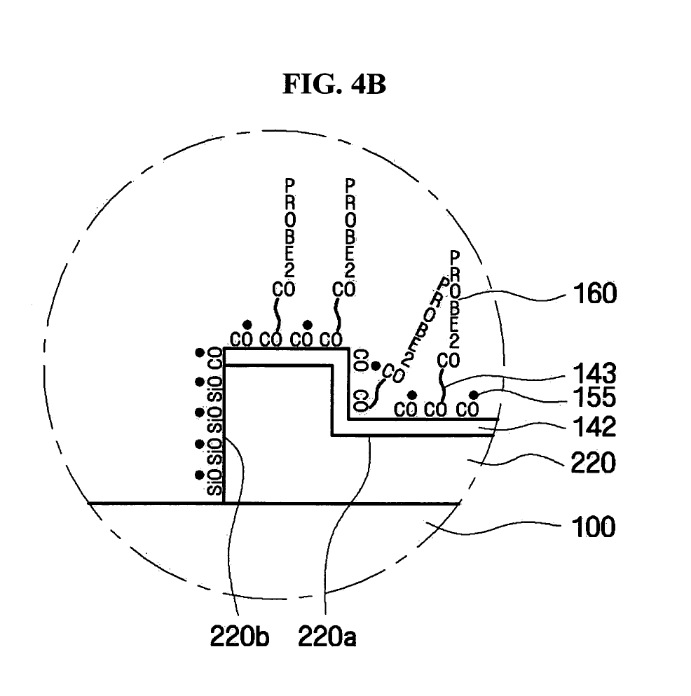

FIG. 4 illustrates a cross-sectional view of a probe array including a plurality of probe cell actives 220. The probe array illustrated in FIG. 4 may be fabricated using the layout illustrated in FIG. 3A or 3B.

The probe array illustrated in FIG. 4 may be substantially similar to the probe array illustrated in FIG. 2, but also including a convoluted top surface of the probe cell actives 220. Thus, a surface area of each of the probe cell actives 220, to which probes 160 may be coupled, may increased even if a design rule applied to the probe array illustrated in FIG. 2 is also applied to the oligomer probe array illustrated in FIG. 4. Accordingly, when the probe array illustrated in FIG. 4 is formed using the same design rule as used for the probe array illustrated in FIG. 2, the number of probes 160 that may be coupled to the probe array may also be increased. Consequently, even if the design rule is reduced, a desired detection intensity may be achieved.

The convoluted top surfaces of the probe cell actives 220 may be formed by, e.g., one or more grooves G in the top surfaces of the probe cell actives 220. It will be appreciated that the configuration of the grooves G may be suitably varied in a number of ways in order to increase the surface area of the probe cell actives 220.

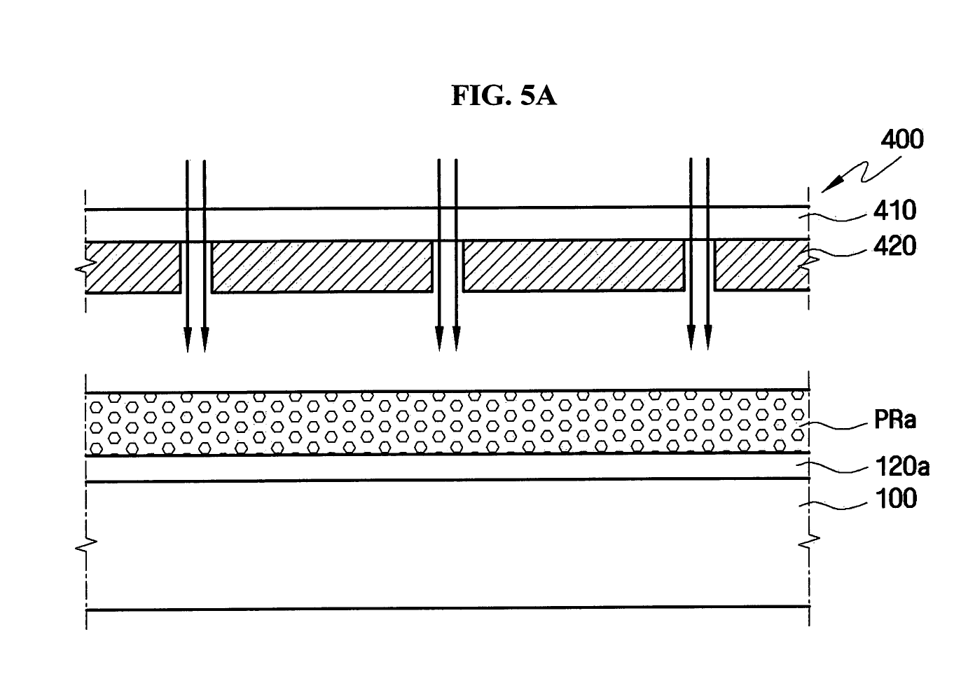

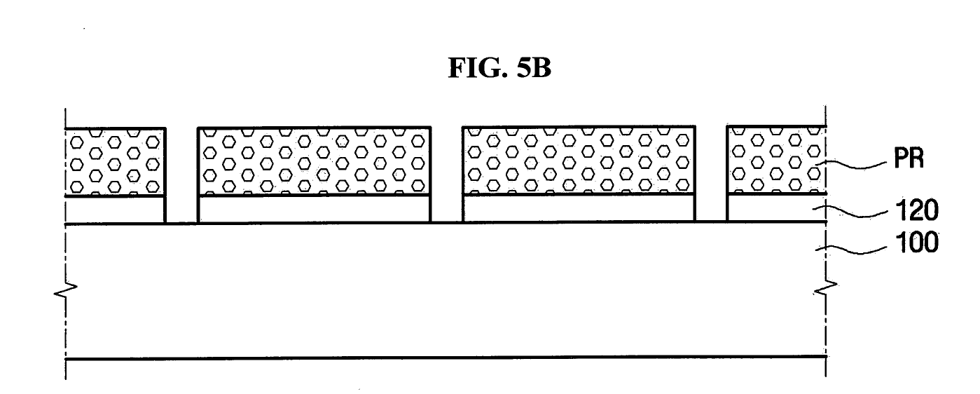

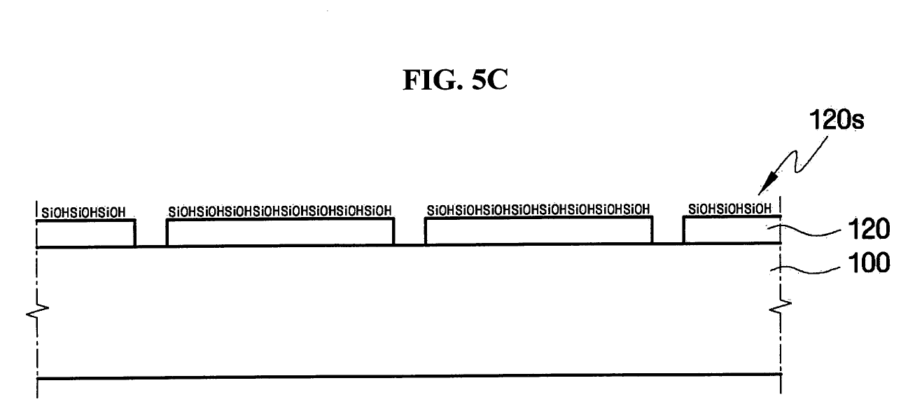

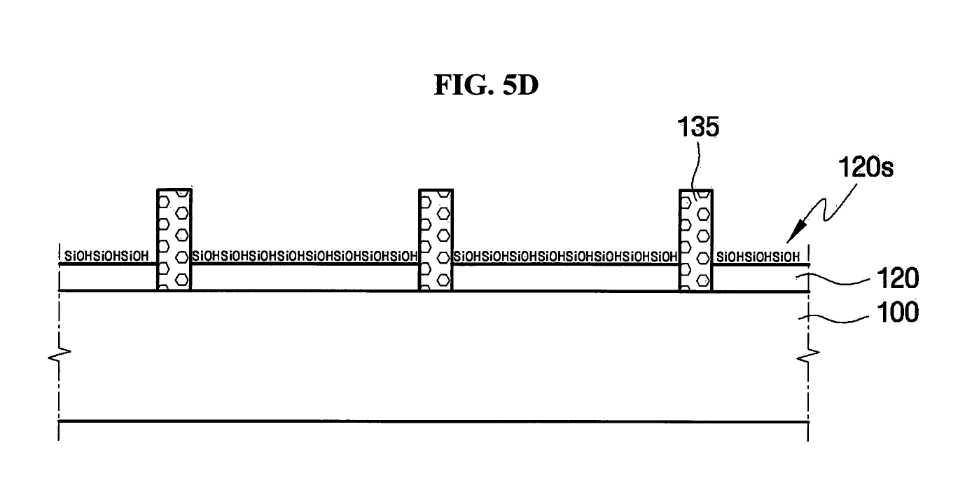

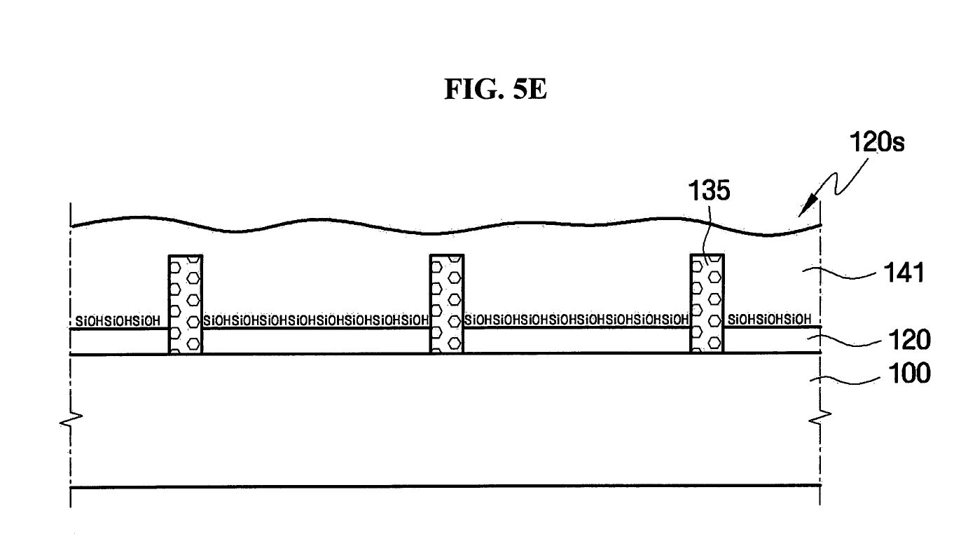

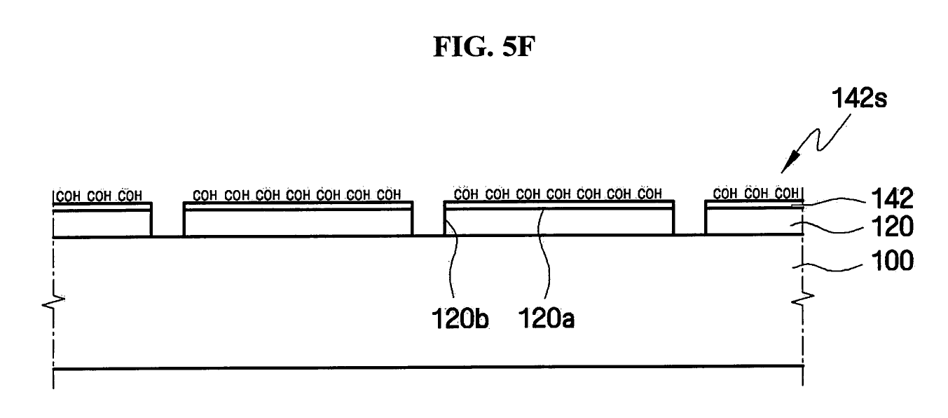

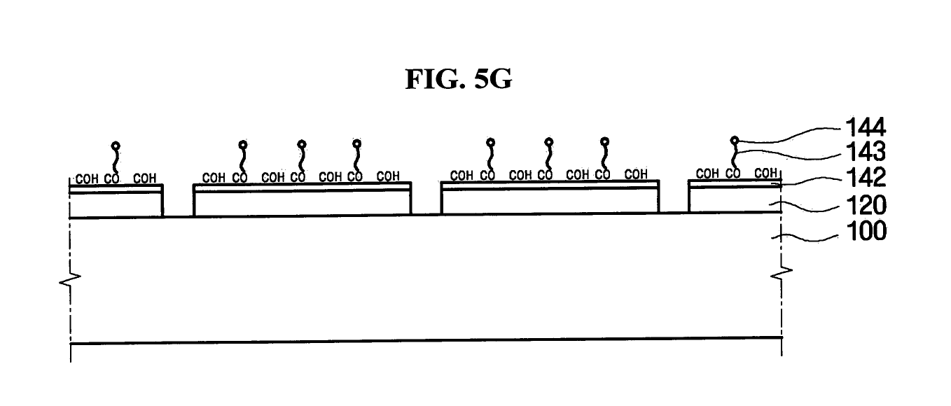

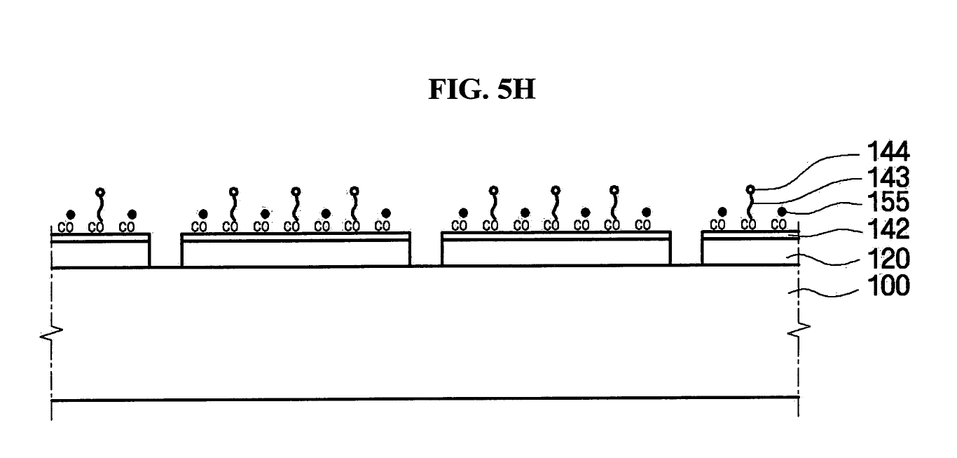

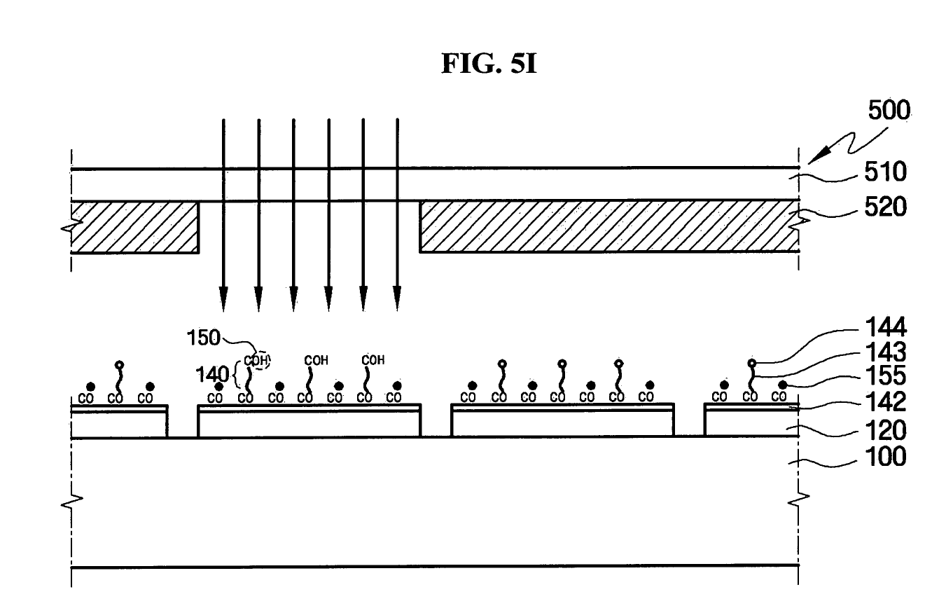

Hereinafter, methods of fabricating a probe array according to embodiments will be described with reference to FIGS. 5A through 8B.

FIGS. 5A through 5I illustrate cross-sectional views of stages in a method of fabricating the probe array illustrated in FIG. 2 according to an embodiment.

Referring to FIG. 5A, a film 120a for forming probe cell actives may be formed on the substrate 100. The film 120a may be formed of, e.g., a silicon oxide film such as a PE-TEOS film, an HDP oxide film, a P—SiH₄ oxide film or a thermal oxide film, a silicate such as a hafnium silicate or a zirconium silicate, a silicon oxy-nitride film, a spin-on siloxane film, or a polymer such as polyacrylate, polystyrene, polyvinyl, a copolymer thereof, or a mixture thereof, etc. The film 120a may be formed using a process such as one typically applied in the process of fabricating semiconductors and/or LCDs, such as chemical vapor deposition (CVD), sub-atmospheric CVD (SACVD), low pressure CVD (LPCVD), plasma enhanced CVD (PECVD), sputtering, spin coating, etc.

A photoresist film PRa may be formed on the film 120a. The photoresist film PRa may be exposed by a projection exposure apparatus that uses a mask 400, which may be fabricated according to, e.g., the layout of FIG. 1A or 1B. The example mask 400 illustrated in FIG. 5A has a light-shielding pattern 420, which defines probe cell actives, on a transparent substrate 410 and has exposure regions in a checkerboard form. It will be appreciated that the form of the light-shielding patterns 420 may be suitably varied according to the type of the photoresist film PRa used.

Referring to FIG. 5B, the exposed photoresist film PRa may be developed to form a photoresist pattern PR. Then, the film 120a may be etched using the photoresist pattern PR as an etching mask. As a result, probe cell actives 120 that are physically separated from each other may be formed. The photoresist pattern PR may then be removed.

Referring to FIG. 5C, a plurality of functional groups may be exposed on a surface 120s of each of the probe cell actives 120 after the photoresist pattern PR is removed. The functional groups may be, e.g., SiOH, where the probe cell actives 120 are formed of silicon oxide films. Thus, SiOH groups, which may be coupled to probes such as oligomer probes, may be exposed on the surface 120s of each of the probe cell actives 120 formed of silicon oxide films.

Referring to FIG. 5D, barrier walls 135 may be formed in probe cell isolation regions that define the probe cell actives 120. The barrier walls 135 may be formed higher than the probe cell actives 120, as illustrated in FIG. 5D. In another implementation (not shown), the barrier walls may be formed to a height substantially even with the top of the probe cell actives 120. Where the barrier walls 135 are formed higher than the probe cell actives 120, the barrier walls 135 may partially enclose the probe cell actives 120, such that each of the probe cell actives 120 may form an individual micro-reactor. The barrier walls 135 may be formed by, e.g., forming, exposing and developing a second photoresist, a photoreactive polymer film, etc.

Referring to FIG. 5E, a linker solution 141 may be provided to the substrate 100 on which the barrier walls 135 are formed. The linker solution 141 may be provided by, e.g., spin-coating the linker solution 141 on the substrate 100, spin-drying an unreacted portion of the linker solution 141, and baking the remaining portion of the linker solution 141. It may be desirable to coat the linker solution 141 as thin as possible during spin coating, so that a linker 142 (see FIG. 5F) may be formed in a monolayer, e.g., a layer having a thickness of less than about 100 nm. When the linker 142 is a monolayer, SNRs of the probes may be effectively improved. In an implementation, spin coating and spin drying may be performed at, e.g., about 50 rpm to about 5,000 rpm. Spin coating may be performed at lower rpm than spin drying, or performed without a spin. Baking may be performed at, e.g., a temperature of about 100° C. to about 140° C.

In an implementation, a silane-based linker solution or a siloxane-based linker solution may be used as the linker solution 141. The silane-based linker solution or the siloxane-based linker solution may include functional groups that have greater coupling reactivity with the probes than the SiOH functional groups of the probe cell actives 120, and which may not be coupled to the probe cell isolation regions 130 formed of a surface of the substrate 100 but rather are coupled to the probe cell actives 120.

Referring to FIG. 5F, the barrier walls 135 may be removed. After removal of the barrier walls 135, the linker 142 may be coupled to surface regions 120a, but not to the edge walls 120b, of each of the probe cell actives 120. Similar effects may be achieved when the barrier walls 135 are formed to a height substantially even with the top of the probe cell actives 120 (not shown). The barrier walls 135 may be removed using, e.g., photoresist thinner, organic photoresist stripper, acetonitrile or acetone. Considering compatibility with a solution used in a subsequent in situ photolithographic synthesis process, it may be desirable to use acetonitrile or acetone. Functional groups, e.g., carbon-bonded hydroxyl groups (COH), which may have greater coupling reactivity with the probes than the SiOH groups of the probe cell actives 120, may be exposed on a surface 142s of the linker 142.

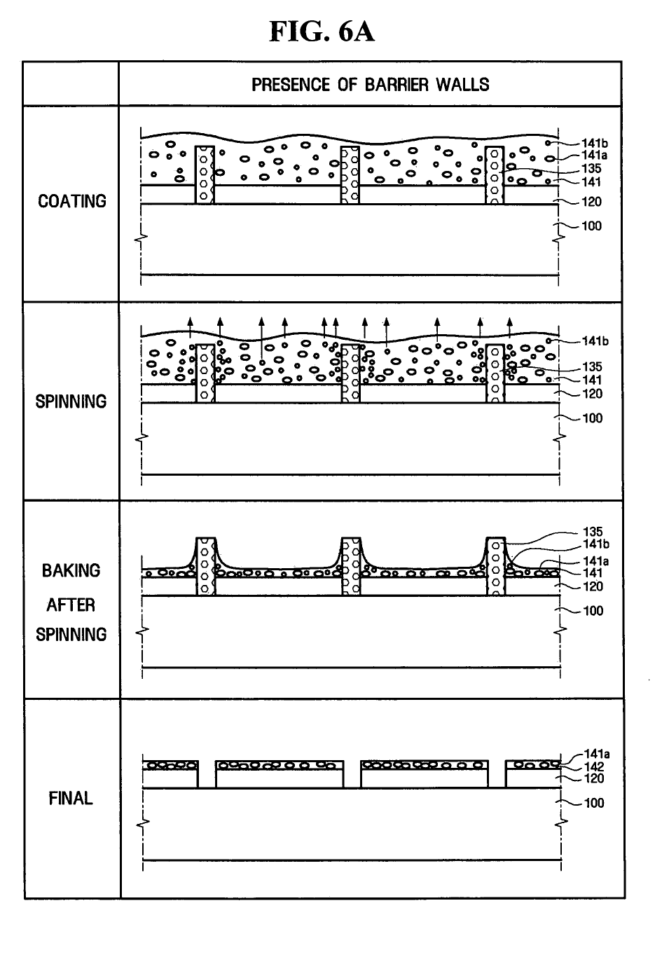

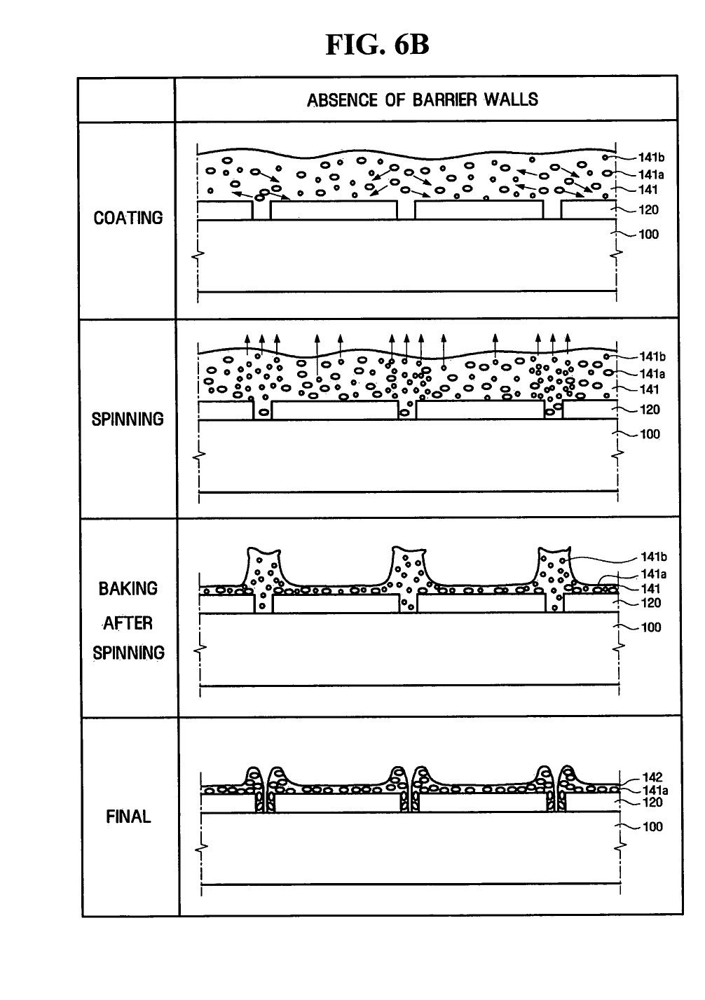

FIG. 6 illustrates a schematic diagram of a mechanism in which the shape of edge walls of a linker varies according to the presence or absence of barrier walls.

Referring to FIG. 6, after the linker solution 141 is coated, it may be spun and then baked. Accordingly, solutes 141a and solvents 141b may be moved and the solvents 141b may be evaporated. As a result, a meniscus may be formed.

In the case that no barrier walls 135 are provided (right side of FIG. 6), when the unreacted portion of the linker solution 141 is removed and the linker solution 141 is baked, the meniscus may directly affect a surface aspect of the linker 142. In particular, meniscus-type edges may be formed in the linker 142.

On the other hand, in the case that the barrier walls 135 are provided according to an embodiment (left side of FIG. 6), a micro reactor may be formed in each of the probe cell actives 120. Coupling between the linker solution 141 and the probe cell actives 120 may be performed in the micro reactor, which may provide improved coupling. As in the case that no barrier walls 135 are provided, a meniscus-type edge may form. However, the meniscus-type edge may be removed when the barrier walls 135 are removed. Therefore, the probe cell actives 120 may not have meniscus-type edges. In addition, edge walls 120b of the probe cell actives 120 may be prevented from coupling to the linker 142. Thus, the edge walls 120b may not exhibit activity toward the subsequently-applied probes. Similar results may be achieved where edge walls 135 having a height substantially even with the top of the probe cell actives 120 are employed.

Referring back to FIG. 5G, the other linker 143, to which photo-labile protecting groups 144 may be bonded, may be coupled to the COH groups of the surface 142s of the linker 142. The other linker 143 may be formed of, e.g., a material that can provide a sufficient length to enable the probes such as oligomer probes to freely interact with a target sample. For example, phosphoamidite, to which photo-labile protecting groups may be bonded, may be used as the other linker 143. The photo-labile protecting groups 144 may be various positive photo-labile groups, e.g., nitroaromatic compounds such as o-nitrobenzyl derivatives or benzylsulfonyl. Other examples of photo-labile protecting groups 144 include 6-nitroveratryloxycarbonyl (NVOC), 2-nitrobenzyloxycarbonyl (NBOC), α,α-dimethyl-3,5-dimethoxybenzyloxycarbonyl (DDZ), and the like.

Referring to FIG. 5H, capping may be performed on remaining functional groups that are exposed on the surface 120s of each of the probe cell actives 120 but are not bonded to the other linker 143, in order to inactivate the remaining functional groups. For example, inactivation may be performed using capping groups 155 that can acetylate the functional groups (e.g., SiOH or COH groups). Subsequently, functional groups protected by the photo-labile protecting groups 144 may be coupled to the probes, and a new linker composed of the linker 142 and the other linker 143 may thus be formed.

Referring to FIG. 5I, each of the photo-labile protecting groups 144 coupled to an end of the linker 143 may be de-protected, e.g., using a mask 500 that exposes the desired probe cell actives 120, for in situ synthesis of the probes. As a result, functional groups 150, e.g., COH functional groups, may be exposed.

In an implementation, predetermined oligomer probes may be coupled to the exposed functional groups 150. In order to synthesize oligonucleotide probes by in situ photolithography, amidite-activated nucleotides with photo-labile protecting groups or nucleoside phosphoamidite monomers with photo-labile protecting groups may be coupled to the exposed functional groups 150. Then, inactivation may be performed by capping those exposed functional groups 150 that have not been coupled to the nucleoside phosphoamidite monomers or the amidite-activated nucleotides. Next, oxidation may be performed in order to convert a phosphite triester structure into a phosphate structure. Thus, if the above-described method, i.e., de-protection of the desired probe cell actives 120, coupling of monomers of a desired sequence, capping for inactivation of functional groups that do not participate in coupling, and oxidation for converting the phosphite triester structure into the phosphate structure, is sequentially repeated, then oligonucleotide probes of a desired sequence may be synthesized with each of the probe cell actives 120.

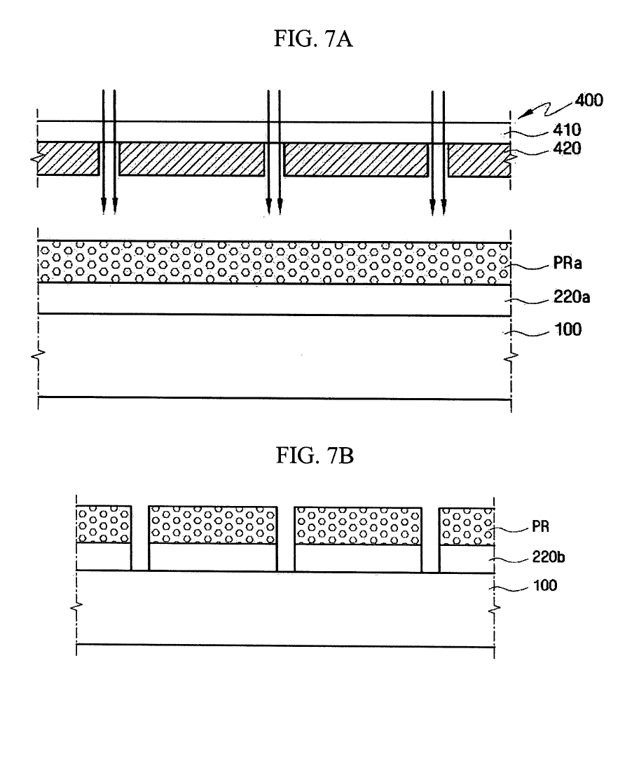

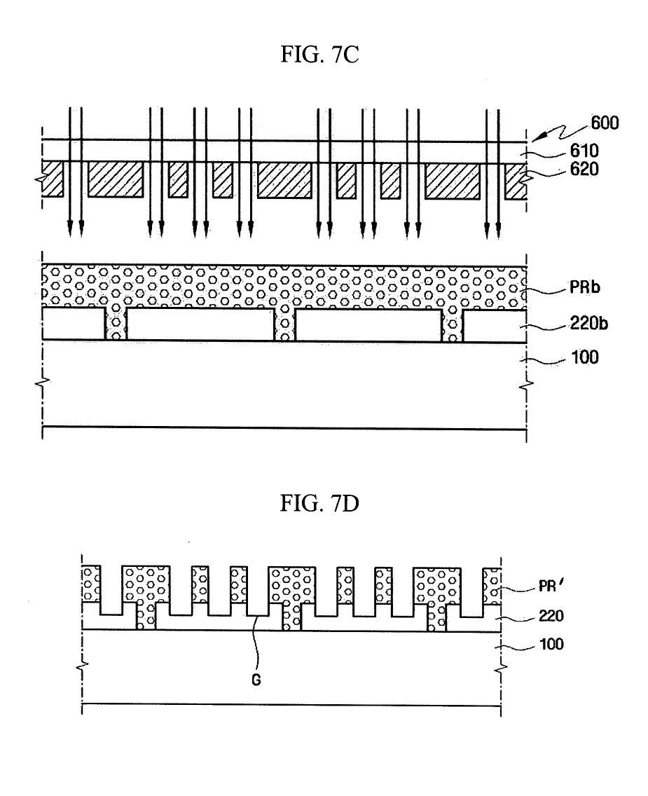

FIGS. 7A through 7D illustrate cross-sectional views of stages in a method of fabricating the probe array illustrated in FIG. 4 according to another embodiment.

Referring to FIG. 7A, a film 220a for forming probe cell actives may be formed on a substrate 100. The film 220a may be substantially the same as the film 120a described above with reference to FIG. 5A. After a photoresist film PRa is formed on the film 220a, it may be exposed using a projection exposure apparatus that uses a mask 400, e.g., a mask fabricated according to the probe cell active patterns 1 illustrated in the layout of FIG. 3A or 3B. The example mask 400 illustrated in FIG. 7A has a light-shielding pattern 420, which defines probe cell actives, on a transparent substrate 410 and has exposure regions in a checkerboard form. The form of the light-shielding patterns 420 may be suitably varied according to the type of the photoresist film PRa used.

Referring to FIG. 7B, the exposed photoresist film PRa may be developed to form a photoresist pattern PR. Then, the film 220a may be etched using the photoresist pattern PR as an etching mask. As a result, a predetermined pattern 220b is formed. The photoresist pattern PR may then be removed

Referring to FIG. 7C, after the photoresist pattern PR is removed, another photoresist film PRb may be coated. Then, the photoresist film PRb may be exposed by a projection exposure apparatus that uses a mask 600, e.g., a mask that is fabricated according to the groove patterns 2 illustrated in the layouts of FIGS. 3A and 3B.

Referring to FIG. 7D, the exposed photoresist film PRb may be developed to form the photoresist pattern PR′ that defines groove patterns. Then, an etching process may be performed using the photoresist pattern PR′ as an etching mask. Consequently, probe cell actives 220, which may have convoluted surfaces due to grooves G formed therein, may be completed.

The subsequent fabrication processes may be substantially the same as the processes described above with reference to FIGS. 5D through 5I and thus will not be repeated.

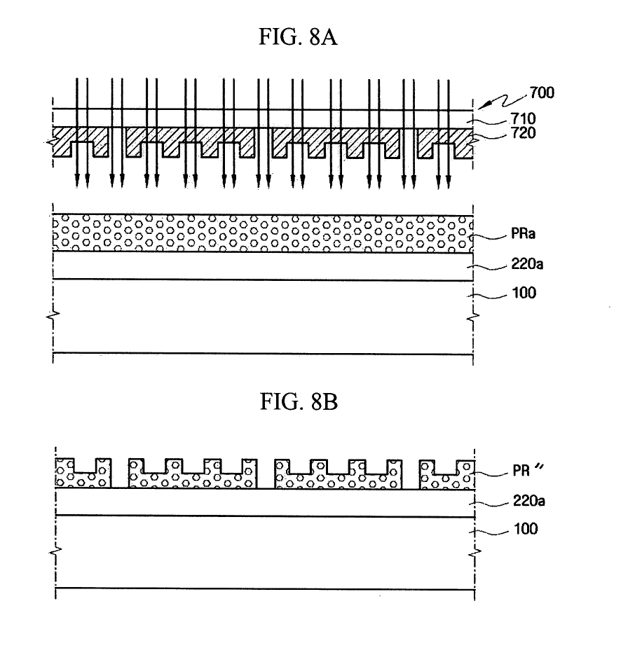

FIGS. 8A and 8B illustrate cross-sectional views of stages in a method of fabricating the probe array illustrated in FIG. 4 according to another embodiment.

Referring to FIG. 8A, a film 220a for forming probe cell actives and a photoresist film PRa may be sequentially formed on a substrate 100. The material for the photoresist film PRa may be chosen to have a predetermined reactivity with respect to the etch process, as described below. Then, the photoresist film PRa may be exposed using a half-tone mask 700. The half-tone mask 700 may a half-tone pattern 720, which corresponds to both the probe cell active patterns 1 and the groove patterns 2, on a transparent substrate 710 according to the layout of FIG. 3A or 3B.

Referring to FIG. 8B, the exposed photoresist film PRa may be developed to form a photoresist pattern PR″ having a convoluted surface. That is, the surface of the photoresist pattern PR″ may include one or more recessed areas that do not extend through the photoresist pattern PR″, such that the photoresist pattern PR″ has regions of varying thickness.

The film 220a may then be etched using the convoluted-surface photoresist pattern PR″ as an etching mask (not shown). In an implementation, the photoresist pattern PR″ may have a predetermined reactivity with respect to the etch process, i.e., the etch may be performed using a process that removes the photoresist pattern PR″ as well as the film 220a. For example, the etch process may remove the photoresist pattern PR″ and the film 220a at a similar rate. Consequently, the probe cell actives 220 of FIG. 4 having convoluted surfaces formed by the grooves G may be produced. This etch process may be a different process from those described above, which may use the photoresist as an etch mask and may remove little or none of the photoresist during the etching process. The subsequent fabrication processes may be substantially the same as the processes described above with reference to FIGS. 5D through 5I and thus will not be repeated.

In an embodiment, a method of analyzing a sample using the probe array includes applying a sample to the probe array, binding at least a portion of the applied sample to one or more active regions of the probe array, and detecting bound portions of the sample. Binding may include, e.g., hybridization, and detecting bound portions of the sample may include, e.g., detecting the presence or absence of fluorescent moieties.

The following Example and Comparative Example are provided in order to set forth particular details of one or more embodiments. However, it will be understood that the embodiments are not limited to the particular details described.

### EXPERIMENTAL EXAMPLE 1

A spin-on siloxane film was formed to a thickness of 900 Å on a silicon substrate. After a photoresist film was formed to a thickness of 1.2 μm on the substrate using a spin coating method, it was baked for 60 seconds at a temperature of 100° C. Then, the photoresist film was exposed with 365 nm-wavelength projection exposure equipment using a checkerboard-type mask with a pitch of 1.0 μm. Next, the photoresist film was developed using a 2.38% tetramethylammonium hydroxide aqueous solution. As a result, a photoresist pattern, which exposed linear regions horizontally and vertically crossing one another in a checkerboard form, was formed. The spin-on siloxane film was etched using the photoresist pattern as an etching mask and then patterned to form oligomer probe cell actives. The photoresist pattern was then removed.

After a second photoresist film was formed to a thickness of 1.2 μm on the substrate using the spin coating method, the oligomer probe cell actives were selectively exposed and developed. Consequently, photoresist barrier walls were formed in probe cell isolation regions.

Next, a silane linker was coupled onto the patterned oligomer probe cell actives. In particular, 0.8 grams of bis(hydroxyethyl)aminopropyl triethoxysilane was dissolved in a mixed solvent (ethanol:H₂O=95:5) to produce a 0.1% silane solution. Then, the 0.1% silane solution was coated on the substrate having the barrier walls and was allowed to react for 60 seconds. After 60 seconds, an unreacted portion of the silane solution was removed using isopropyl alcohol, and the substrate was spin-dried at 1500 to 2500 rpm for three minutes. Next, the spin-dried substrate was baked at a temperature of 110° C. for ten minutes, thereby hardening the silane solution that was coupled to the oligomer probe cell actives. Then, the photoresist barrier walls were removed using an acetonitrile solution so that the silane linker was coupled to top surfaces, but not edge walls, of the probe cell actives. The probe cell actives were thus physically separated from one another and formed to have a structure projecting above the substrate. Consequently, the probe cell actives, which were physically separated from one another by recessed regions and chemically separated from one another by non-linker-containing regions including non-linker containing edge walls, were completed. Then, the substrate was treated with an acetonitrile solution with an amidite-activated NNPOC-tetraethyleneglycol/tetrazole ratio of 1:1. Accordingly, the functional groups were coupled with phosphoamidite protected by photo-labile groups and acetyl-capped, thereby forming a protected linker structure.

Subsequently, an in situ synthesis of oligonucleotide probes on the substrate, which included oligomer probe cell actives and probe cell isolation regions, was performed using photolithography. In particular, a binary chrome mask was first used to expose desired probe cell active regions. Then, exposing was performed for one minute using the 365 nm-wavelength projection exposure equipment with an energy of 1000 mJ/cm², thereby de-protecting an end of the linker structure. Next, coupling of protected monomers was performed by treating the acetonitrile solution with a nucleotide/tetrazole ratio of 1:1 at room temperature. The nucleotide was protected by photo-labile protecting groups and was amidite-activated. In addition, capping and oxidation processes were performed by treating with a tetrahydrofuran (THF) solution of acetic anhydride (Ac₂O)/pyridine (py)/methylimidazole, which were combined in a ratio of 1:1:1, and by treating with a 0.02 M iodine THF solution.

The above de-protection, coupling, capping, oxidation processes were repeated to synthesize oligonucleotide probes of different sequences with each probe cell active.

In an embodiment, a method of analyzing a sample using the probe array includes applying a sample to the probe array, binding at least a portion of the applied sample to one or more active regions of the probe array, and detecting bound portions of the sample. Binding may include, e.g., hybridization, and detecting bound portions of the sample may include, e.g., detecting the presence or absence of fluorescent moieties.

### COMPARATIVE EXAMPLE

Oligonucleotide probes were synthesized in the same way as in the above-described Example, except that barrier walls were not formed in probe cell isolation regions.

### Comparison of Example and Comparative Example

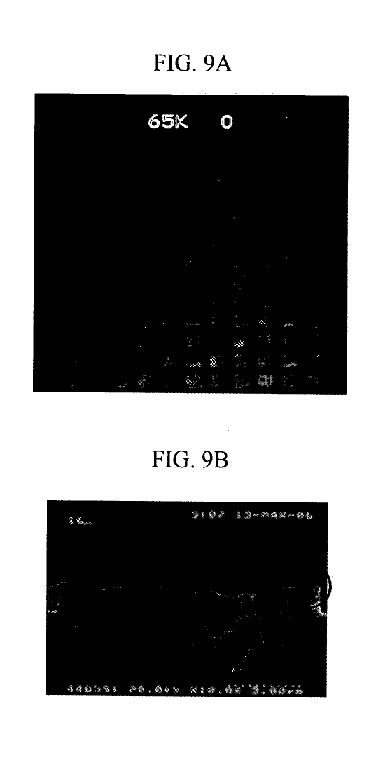

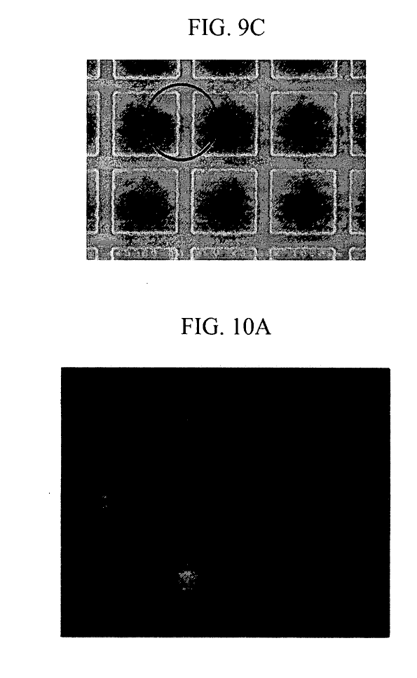

Contrast of probe cell actives, to which a silane linker was coupled, with probe cell isolation regions was measured for the Example and the Comparative Example. The results of the contrast measurement, as well as a scanning electron microscope (SEM) cross-sectional view and an SEM plan view of the probe cell actives are illustrated for the Example and Comparative Example in FIGS. 9A through 9C and FIGS. 10A through 101C, respectively.

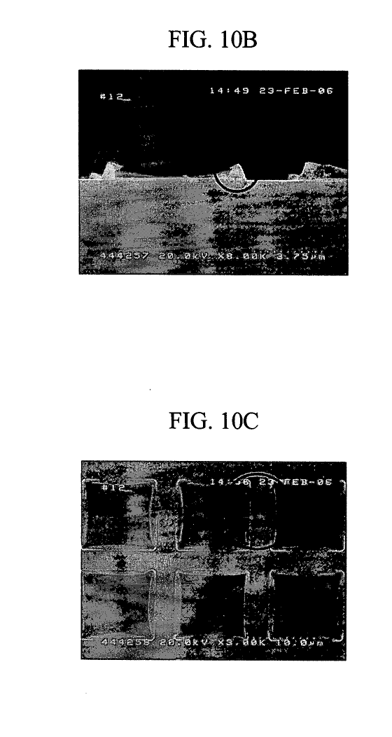

Referring to FIG. 9A, the contrast measurement of probe cell actives/probe cell isolation regions of the Example, which were formed using barrier walls according to an embodiment, was excellent at about 64 k/0. On the other hand, as shown in FIG. 10A, the contrast measurement of probe cell actives/probe cell isolation regions of the Comparative Example, which were formed without using barrier walls, had a Gaussian distribution of 0 through 40 k. Thus, the contrast was very low.

Referring to FIGS. 9B and 9C, in the case of the probe cell actives formed using the barrier walls according to an embodiment, analysis of the Example showed that meniscus-type edges were not formed in the silane linker and the silane linker was coupled only to a top surface, i.e., the silane linker was not coupled to edge walls, of each probe cell active. On the other hand, referring to FIGS. 10B and 10C, in the case of the probe cell actives formed without using the barrier walls, analysis of the Comparative Example showed that meniscus-type edges were formed in the silane linker and the silane linker was coupled to edge walls, as well as top surfaces, of each probe cell active.

As described above, a probe array according to embodiments may include a plurality of probe cell actives physically and chemically separated from one another. Specifically, the probe cell actives may be physically separated from one another by probe cell isolation regions, and may be chemically separated from one another by a linker that is coupled only to top regions, i.e., excluding edge walls, of each probe cell active. Therefore, probes, such as oligomer probes, may be coupled to a top surface of each probe cell active, but not coupled to the edge walls thereof or to probe cell isolation regions surrounding the probe cell actives. Consequently, a SNR may be increased and crosstalk may be reduced, thereby enhancing the accuracy of analysis based on the probes.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A probe array, comprising:
a substrate having at least two projecting features adjacent to one another, each feature including a top surface and a side surface;
an isolation region separating the at least two features;
at least two active regions, the at least two active regions including the top surfaces of the at least two features; and
an inactive region separating the at least two active regions, the inactive region including the isolation region.

2. The probe array as claimed in claim 1, wherein the inactive region includes the side surfaces of the features.

3. The array as claimed in claim 1, wherein:
the active regions have probes coupled thereto, and
the inactive region has no probes coupled thereto.

4. The array as claimed in claim 3, wherein the probes are oligomer probes.

5. The array as claimed in claim 1, wherein the active regions include a linker, and
the inactive region does not include the linker.

6. The array as claimed in claim 5, wherein the top surfaces and the side surfaces all include a first type of functional group,
the linker is bonded to the functional group on the top surfaces, and
the linker is not bonded to the functional group on the side surfaces.

7. The array as claimed in claim 5, wherein the linker is a silane-based linker or a siloxane-based linker.

8. The array as claimed in claim 5, wherein the inactive region includes the side surfaces.

9. The array as claimed in claim 1, wherein the features are silicon oxide, siloxane, or polymeric.

10. The array as claimed in claim 1, wherein the top surfaces are convoluted.

11. The array as claimed in claim 1, wherein the substrate is a silicon substrate or a transparent glass substrate, and the isolation region is an exposed surface of the substrate.

12. A method of fabricating a probe array, the method comprising:
forming at least two projecting features adjacent to one another on a substrate, each feature including a top surface and a side surface, and an isolation region separating the at least two features; and
forming at least two active regions, the at least two active regions including the top surfaces of the at least two features, and an inactive region separating the at least two active regions, the inactive region including the isolation region.

13. The method as claimed in claim 12, wherein the inactive region includes the side surfaces of the features.

14. The method as claimed in claim 12, wherein forming the active regions and the inactive region includes forming barrier walls in the isolation region.

15. The method as claimed in claim 14, wherein the barrier walls extend above the top surfaces of the features.

16. The method as claimed in claim 14, wherein the barrier walls include one or more of a photoresist or a photoreactive polymer.

17. The method as claimed in claim 12, further comprising binding probes to the active regions.

18. The method as claimed in claim 17, wherein the inactive region includes the side surfaces.

19. The method as claimed in claim 17, wherein the probes are oligomer probes.

20. The method as claimed in claim 17, wherein binding the probes to the active regions includes binding a linker to the active regions while the barrier walls are in the isolation region, and then removing the barrier walls.

21. The method as claimed in claim 17, wherein binding the probes to the active regions includes binding the probes to the active regions while the barrier walls are in the isolation region, and then removing the barrier walls.

22. The method as claimed in claim 12, wherein the top surfaces are convoluted.

23. A method of analyzing a sample using a probe array, the method comprising:
applying a sample to the probe array;
binding at least a portion of the applied sample to one or more active regions of the probe array; and
detecting bound portions of the sample, wherein the probe array includes:
a substrate having at least two projecting features adjacent to one another, each feature including a top surface and a side surface;
an isolation region separating the at least two features;
at least two active regions, the at least two active regions including the top surfaces of the at least two features; and
an inactive region separating the at least two active regions, the inactive region including the isolation region.
